(19) United States
(12) Patent Application Publication
(10) Pub. No.: US 2025/0390666 A1
(43) Pub. Date: Dec. 25, 2025

(54) INFORMATION PROCESSING APPARATUS, INFORMATION PROCESSING SYSTEM, INFORMATION PROCESSING METHOD, AND PROGRAM

(71) Applicants: Shinta MUTO, Tokyo (JP); Naoki YOSHIKAWA, Tokyo (JP)

(72) Inventors: Shinta MUTO, Tokyo (JP); Naoki YOSHIKAWA, Tokyo (JP)

(21) Appl. No.: 19/240,017

(22) Filed: Jun. 17, 2025

(30) Foreign Application Priority Data
Jun. 20, 2024 (JP) 2024-099341

(51) Int. Cl. G06F 40/166; G06F 3/041

(52) U.S. Cl. CPC G06F 40/166; G06F 3/0412

(57) ABSTRACT

An information processing apparatus comprises processing circuitry configured to receive document data from a document scanned by a scanner, the document data including an image and correction instructions; input the document data to a correction information estimation model; receive, from the correction information estimation model, first correction information in response to the input of the document data; generate a first corrected image by correcting the document data based on the first correction information; display the first corrected image; and accept, from a user, input of second correction information corresponding to the original document data.

### CROSS-REFERENCE TO RELATED APPLICATION

This patent application is based on and claims priority pursuant to 35 U.S.C. § 119 (a) to Japanese Patent Application No. 2024-099341, filed on Jun. 20, 2024, in the Japan Patent Office, the entire disclosure of which is hereby incorporated by reference herein.

### BACKGROUND

### Technical Field

Embodiments of this disclosure relate to an information processing apparatus, an information processing system, an information processing method, and a program.

### Related Art

An image processing technology is known that automatically reflects specified corrections to an image read from a document on which handwritten correction instructions are written. An image forming device is known that reads an image from a document on which corrections (additions or modifications) have been made, extracts an image corresponding to the added parts, and corrects the original image based on the instructions indicated by the extracted parts.

### SUMMARY

In accordance with an embodiment of this disclosure, an information processing apparatus comprises processing circuitry configured to receive document data from a document scanned by a scanner, the document data including an image and correction instructions; input the document data to a correction information estimation model; receive, from the correction information estimation model, first correction information in response to the input of the document data; generate a first corrected image by correcting the document data based on the first correction information; display the first corrected image; and accept, from a user, input of second correction information corresponding to the original document data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram showing an example configuration of an information processing system a.

FIG. 2 is a schematic diagram showing a hardware configuration example of the image forming apparatus 10.

FIG. 3 is a schematic diagram showing a hardware configuration example of a server apparatus 20.

FIG. 4 is a schematic diagram showing an example of the functional configuration of the information processing system 1.

FIG. 5 is a flowchart illustrating an example of the processing steps for generating training data for the correction information estimation model 23.

FIGS. 6A-6D are diagrams for explaining the specification of correction symbols, cancellation portions, and correction portions.

FIGS. 7A and 7B are diagrams for explaining the specification of the destination to which a correction portion is moved.

FIGS. 8A-8D show other examples of correction instructions.

FIG. 9 is a flowchart illustrating an example of the processing steps for correcting the manuscript data.

FIG. 10 is a sequence diagram illustrating an example of the processing steps for correcting the manuscript data.

FIG. 11 shows an example of the display of the first corrected image.

FIG. 12 shows an example of the display of the manuscript data.

FIG. 13 shows an example of the display of the second corrected image.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described in detail below. As used herein, the singular forms “a,” “an,” and “the” are intended to include the plural forms as well, unless the context clearly indicates otherwise.

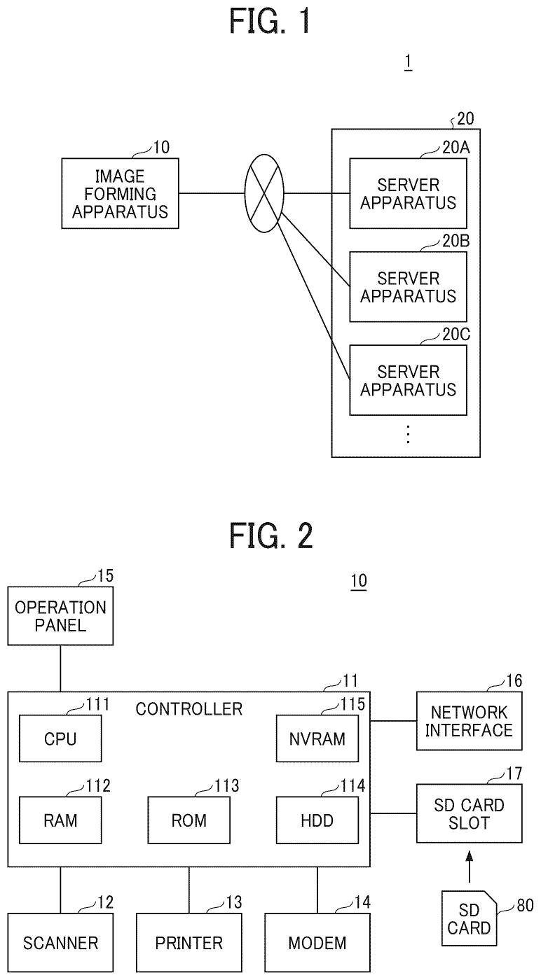

Hereinafter, embodiments of the present disclosure will be described with reference to the drawings. FIG. 1 illustrates an example configuration of an information processing system 1. As shown in FIG. 1, the information processing system 1 includes an image forming apparatus 10 and a server apparatus 20. The image forming apparatus 10 is connected to the server apparatus 20 via a network such as a LAN (Local Area Network) or the Internet.

The image forming apparatus 10 is an information processing device that reads image data from a document and performs various processing on the image data. Correction instructions are appended (i.e., handwritten additions) to the document. The correction instructions indicate modifications such as changes to the characters contained in the document or changes in the positions of the characters. The image forming apparatus 10 performs corrections on the data—which comprises image data read from the document (hereinafter “document data”)—in accordance with the correction content indicated by the correction instructions, thereby generating an image corresponding to the corrected image data (hereinafter “corrected image”). The characters contained in the document may be handwritten or printed. Further, the correction instructions may be appended by handwriting or by any other method.

The server apparatus 20 receives the document data from the image forming apparatus 10 and generates information indicating the correction content (hereinafter “correction information”) that is implied by the correction instructions contained in the document data. The server apparatus 20 then transmits the generated correction information to the image forming apparatus 10. The correction information mechanically represents the content of the correction. Accordingly, the image forming apparatus 10 can perform corrections on the document data based on the correction information. The generation (or estimation) of the correction information is performed by using a trained machine learning model. The server apparatus 20 may be constituted by a single computer or by a plurality of computers.

FIG. 2 is a diagram illustrating an example hardware configuration of the image forming apparatus 10. In FIG. 2, the image forming apparatus 10 includes hardware such as a controller 11, a scanner 12, a printer 13, a modem 14, an operation panel 15, a network interface 16, and an SD card slot 17.

The controller 11 comprises a CPU 111, RAM 112, ROM 113, an HDD 114, and NVRAM 115. The ROM 113 stores various programs and data utilized by the programs. The RAM 112 is used as a storage area for loading programs and as working space for the loaded programs. The CPU 111 executes the functions by processing the programs loaded into the RAM 112. The HDD 114 stores the programs and various data used by the programs, and the NVRAM 115 stores various setting information. Moreover, each function of the present disclosure may be implemented using one or more circuits or processing circuitry. Here, “processing circuitry” includes, for example, a processor implemented by an electronic circuit and programmed to execute the respective functions by software, an application-specific integrated circuit (ASIC) designed to perform the functions described above, a digital signal processor (DSP), a field-programmable gate array (FPGA), or conventional circuit modules. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The scanner 12 is hardware for reading image data from a document. The printer 13 is hardware for printing print data onto print paper. The modem 14 is hardware for connecting to a telephone line and is used to perform the transmission and reception of image data by facsimile communication. The operation panel 15 is hardware that includes an input interface such as buttons for accepting user input and a display such as an LCD panel to display processing results of the image forming apparatus 10. The LCD panel may also have a touch panel function, whereby it simultaneously functions as an input interface. The network interface 16 is hardware for connecting to a network (wired or wireless, regardless of type) such as a LAN. The SD card slot 17 is used to read programs stored on an SD card 80. That is, in the image forming apparatus 10 not only the program stored in the ROM 113 but also the program stored on the SD card 80 may be loaded into the RAM 112 and executed. Further, the SD card 80 may be replaced by other recording media (for example, a CD-ROM or a USB memory); the type of recording medium corresponding to the SD card 80 is not limited to a predetermined one. In such cases, the SD card slot 17 may be substituted by hardware appropriate for the type of recording medium.

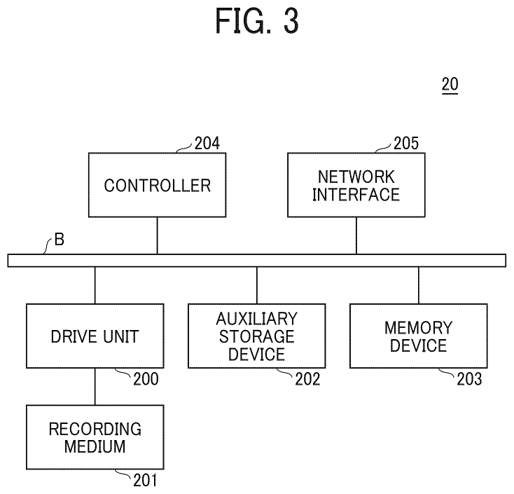

FIG. 3 is a diagram illustrating an example hardware configuration of the server apparatus 20. The server apparatus 20 in FIG. 3 includes, for example, a drive unit 200, an auxiliary storage device 202, a memory device 203, a processor 204, and an interface device 205, which are interconnected by a bus B.

A program for executing the processing in the server apparatus 20 is provided by a recording medium 201. When the recording medium 201 storing the program is set in the drive unit 200, the program is installed from the recording medium 201 to the auxiliary storage device 202. However, installation of the program is not necessarily performed from the recording medium 201; it may be downloaded from another computer via a network. The auxiliary storage device 202 stores the installed program along with necessary files and data.

The memory device 203 reads and stores the program from the auxiliary storage device 202 when a program start instruction is issued. The controller 204, which may be circuitry as discussed above, and may include a CPU, a GPU (Graphics Processing Unit), or both, executes functions related to the server apparatus 20 according to the program stored in the memory device 203. The interface device 205 is used as an interface for connecting to the network.

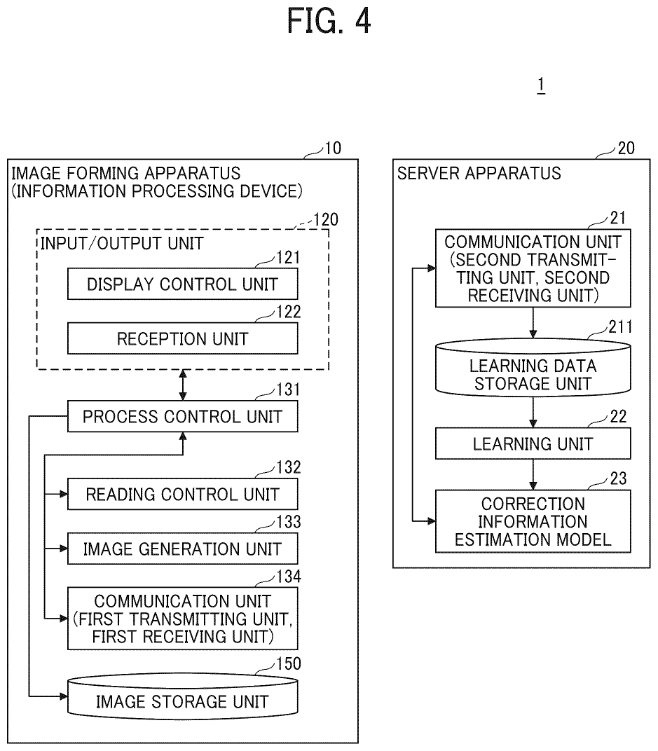

FIG. 4 is a diagram illustrating an example functional configuration of the information processing system 1. In FIG. 4, the server apparatus 20 includes a communication unit 21, a learning unit 22, and a correction information estimation model 23. These components are realized by one or more programs installed in the server apparatus 20 and executed by the controller 204 utilizing interface device 205 and accessing devices including drive unit 200, recording medium 201, auxiliary storage device 202 and memory device 203.

The server apparatus 20 also utilizes a learning data storage unit 211, which may be implemented, for example, by the auxiliary storage device 202 or by a storage device that can be connected to the server apparatus 20 via a network.

The correction information estimation model 23 is a machine learning model (for example, a neural network) that takes as input image data containing correction instructions and outputs the estimated correction information indicated by the correction instructions.

The communication unit 21 communicates with the image forming apparatus 10. For example, the communication unit 21 receives learning data for the correction information estimation model 23 from the image forming apparatus 10. The learning data is generated by the image forming apparatus 10. As described above, the input to the correction information estimation model 23 is the learning data, and the output from the correction information estimation model 23 is the correction information. Thus, the learning data comprises a pair consisting of input image data (here, the document data) and the corresponding correct correction information for the document data. The communication unit 21 stores the received learning data. The communication unit 21 also functions as a second receiving unit for receiving image data containing correction instructions from the image forming apparatus 10, and further functions as a second transmitting unit for transmitting the correction information output by the correction information estimation model 23 to the image forming apparatus 10.

The learning unit 22 trains the correction information estimation model 23 using the learning data stored in the learning data storage unit 211. For each set of learning data, the learning unit 22 trains the correction information estimation model 23 so that the output obtained by inputting the document data contained in the learning data approximates the correction information contained in the learning data. In this manner, the correction information estimation model 23 learns the correspondence between document data with correction instructions and the corresponding correction information.

The image forming apparatus 10 includes a display control unit 121, a reception unit 122, a process control unit 131, a reading control unit 132, an image generation unit 133, and a communication unit 134. These components are realized by one or more programs installed in the image forming apparatus 10 and executed by the CPU 111 which utilizes devices including scanner 12, printer 13, modem 14, operation panel 15 and network interface 16 and accesses devices including SD card slot 17, RAM 112, ROM 113, HDD 114 and NVRAM 115. The image forming apparatus 10 further utilizes an image storage unit 150.

The image storage unit 150 may be implemented, for example, by the HDD 114 or by a storage device that can be connected to the image forming apparatus 10 via a network.

The reading control unit 132 controls the scanner 12 so as to obtain the image data (document data) read from the document by the scanner 12. Document data of a document to which correction instructions have been appended is obtained.

The image generation unit 133 generates a first corrected image by correcting the document data based on the first correction information output by the correction information estimation model 23 that inputs the document data containing the image read from the document with appended correction instructions. Moreover, if the first correction information is modified by the user into second correction information, the image generation unit 133 generates a second corrected image by correcting the document data based on the second correction information.

The display control unit 121 displays, on the operation panel 15, a screen for accepting instructions from the user with respect to the image forming apparatus 10, such as the processing result produced by the image forming apparatus 10. For example, the display control unit 121 displays the corrected image generated by the image generation unit 133 for the document data.

The reception unit 122 accepts input from the user. For example, during generation of learning data for the correction information estimation model 23, the reception unit 122 accepts input from the user of the correction information (as the correct answer) for the document data that is used as learning data. In addition, during inference after training of the correction information estimation model 23, if the first corrected image generated by the image generation unit 133 based on the first correction information output by the correction information estimation model 23 is judged by the user to be unacceptable, the reception unit 122 accepts input of second correction information for the document data from the user.

The display control unit 121 and the reception unit 122 constitute the input/output unit 120.

The process control unit 131 controls processing corresponding to the input received by the reception unit 122. The process control unit 131 also controls the process for transmitting the document data to the server apparatus 20 and for receiving from the server apparatus 20 the correction information output by the correction information estimation model 23 when the document data is input thereto.

The communication unit 134 relays communication with the server apparatus 20 conducted by the process control unit 131 and others.

The image storage unit 150 stores image data of the corrected image generated by the image generation unit 133 that the user has judged to be acceptable.

Next, the processing steps executed by the information processing system 1 will be described.

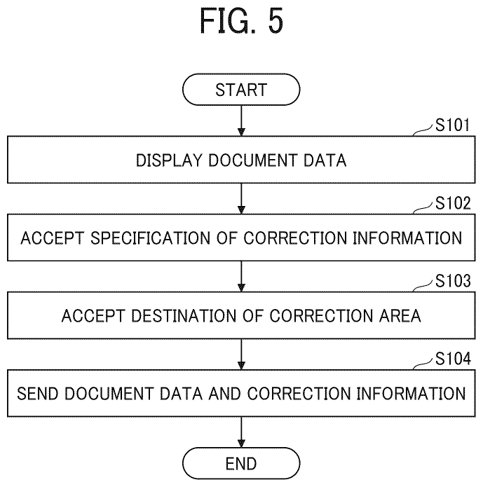

First, the processing steps executed during generation of learning data for the correction information estimation model 23 will be described. FIG. 5 is a flowchart illustrating one example of the processing steps for generating learning data for the correction information estimation model 23. At the start of the processing in FIG. 5, a document with appended correction instructions is set in the scanner 12 of the image forming apparatus 10.

In step S101, the display control unit 121 displays, on the operation panel 15, the image data of the document (document data) read by the reading control unit 132 using the scanner 12. In an exemplary implementation, the document contains appended correction instructions, such as those written on the document by a user. In step S102 and thereafter, processing is executed to accept annotation (i.e., semantic assignment) from the user regarding the correction instructions (the added portions) contained in the displayed document data. Here, “annotation” means specifying the correction information indicated by the correction instructions. That is, the annotation specifies what kind of correction is intended by the correction instructions.

In step S102, the reception unit 122 accepts from the user the specification of the correction information. The correction information includes one or more of a correction symbol, a cancellation area, and a correction arca.

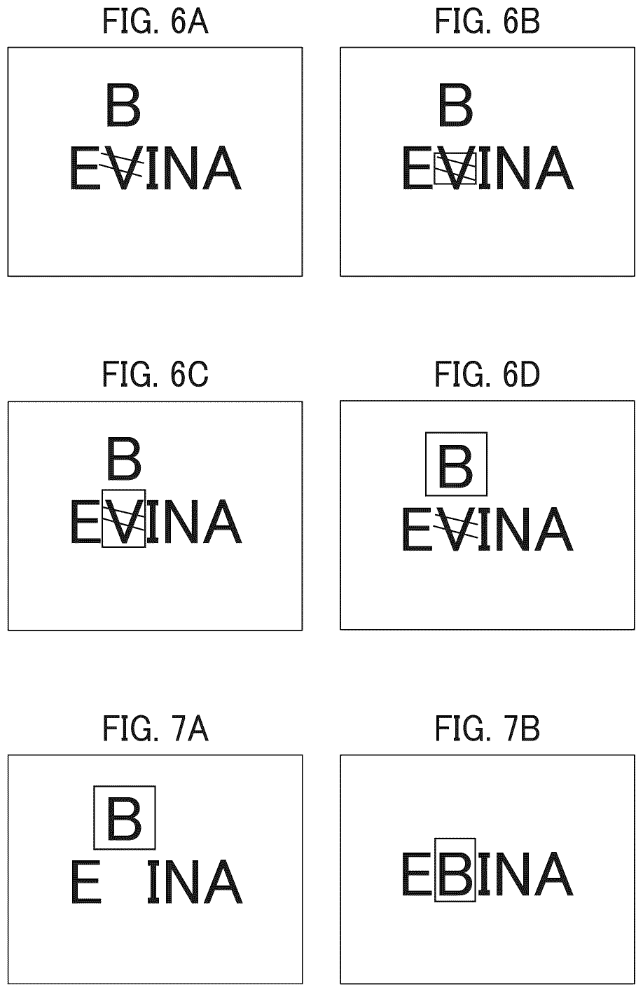

FIGS. 6A-6D are diagrams for explaining the specification of the correction symbol, cancellation area, and correction arca.

In FIG. 6A, a state in which document data is displayed on a touch panel of the operation panel 15 in step S101 is shown. In this example, a double line is appended (added) to the character “V” in the word “EBINA” and the character “B” is appended (added) above the double line.

The correction symbol means information (such as a symbol, character, mark, or figure) that indicates the correction method. In the examples of FIGS. 6A-6D, the double line appended to “B” corresponds to the correction symbol.

The cancellation area means the portion that is to be deleted (cancelled) by the correction indicated by the correction symbol. In the examples of FIGS. 6A-6D, the character “V” corresponds to the cancellation area. Note that the correction symbol is not limited to a symbol indicating deletion; it may also indicate insertion, relocation, etc.

The correction area means the portion (or part) designated as the target for relocation (correction). In the examples of FIGS. 6A-6D, the user's correction instruction intends to replace the character “V” with the character “B”, that is, to relocate the character “B” to the position of “V”. Thus, in this example, the character “B” corresponds to the correction area. Although the examples of FIGS. 6A-6D show an appended character as the correction area, an existing string of characters may also be the target for relocation (i.e., serve as the correction area). For example, if an existing string is to be relocated to another position, the string may serve as the correction arca.

FIG. 6B shows the state in which the correction symbol is specified in step S102. For example, the user draws an inscribed rectangle on the touch panel (for example, with their finger or by using a stylus) corresponding to the correction symbol. In other words, the user draws a rectangle enclosing the correction symbol. In FIG. 6B, the double line is enclosed by a rectangle.

FIG. 6C shows the state in which the cancellation area is specified in step S102. For example, the user draws an inscribed rectangle on the touch panel corresponding to the cancellation area. In other words, the user draws a rectangle enclosing the cancellation arca. In FIG. 6C, the character “V” is enclosed by a rectangle.

FIG. 6D shows the state in which the correction area is specified in step S102. For example, the user draws an inscribed rectangle on the touch panel corresponding to the correction area. In other words, the user draws a rectangle enclosing the correction area. In FIG. 6D, the character “B” is enclosed by a rectangle.

For each rectangle, for example, the user may specify two points, and the reception unit 122 may automatically generate and display a rectangle having these two points as diagonal vertices. Further, whether the input from the user corresponds to the correction symbol, cancellation area, or correction area may be selected from a menu displayed on the operation panel 15 along with the document data.

The reception unit 122 records coordinate information that can specify the position and shape of each rectangle, such as the coordinate information of the upper-left and lower-right vertices, in the RAM 112. The coordinate information refers to coordinate values (X-coordinate, Y-coordinate) in the coordinate system of the document data. The coordinate system of the document data is, for example, a two-dimensional coordinate system in which one vertex (for example, the upper-left vertex) of the document data is taken as the origin and pixels are the unit.

Following step S102, in step S103 the reception unit 122 accepts from the user the specification of the post-correction arrangement (destination) for the correction arca.

FIGS. 7A and 7B are diagrams for explaining the specification of the relocation destination for the correction area. As shown in FIG. 7A, when specifying the relocation destination for the correction area, the reception unit 122 hides the correction symbol and the correction area specified in step S102.

FIG. 7B shows the state of accepting the relocation destination for the correction area. The user, by a touch operation, moves the correction area (the rectangular region) to a desired destination (for example, by drag or drag-and-drop). When the user inputs an instruction indicating the completion of the move, the reception unit 122 records the coordinate information of the relocation destination for the correction area in the RAM 112.

Thus, the acceptance of the user's annotation of the correction information is completed. Accordingly, the correction information may include the following information: coordinates of the correction symbol; coordinates of the cancellation area; and coordinates of the pre-correction position (prior to relocation) and the post-correction position (after relocation) of the correction arca.

Subsequently, the reception unit 122 transmits, via the communication unit 134, the pair of original document data and correction information to the server apparatus 20 (S104). The communication unit 21 of the server apparatus 20 stores the received pair as learning data in the learning data storage unit 211 for the correction information estimation model 23.

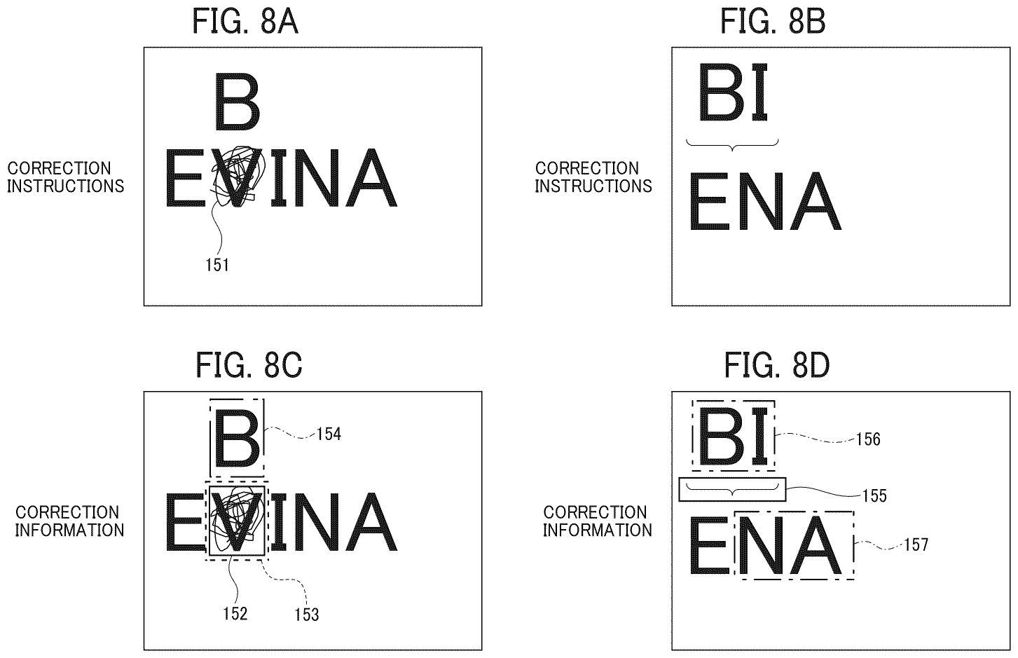

The correction instructions are not limited to the examples shown in FIGS. 6A-7B. FIGS. 8A-8D illustrate additional examples of correction instructions.

FIG. 8A illustrates a first example of a correction instruction, and FIG. 8B illustrates a second example of a correction instruction. FIG. 8C illustrates correction information corresponding to the correction instruction of FIG. 8A, and FIG. 8D illustrates correction information corresponding to the correction instruction of FIG. 8B.

The correction instruction in FIG. 8A is an example in which the cancellation of characters is indicated by an irregular shape (trajectory). In this case, as shown in FIGS. 8A and 8C, the irregular shape 151 is designated as the correction symbol 152, the character (“V”) drawn over by the irregular shape is specified as in the cancellation area 153, and the character (“B”) placed above the cancellation area is specified as in the correction area 154. The relocation destination of the correction arca 153 is designated.

The correction instruction in FIG. 8B is an instruction to insert a string. As shown in FIG. 8D, a symbol indicating insertion is designated as the correction symbol, the string (“BI”) attached above the correction symbol 155 and is in correction area 156, and the string (“NA”) whose position is shifted by the insertion is specified as in the correction arca 157. The relocation destination for each correction area 156 and 157 is also designated.

It should be noted that the above correction instructions are merely examples, and various other correction instructions may be appended.

Moreover, a single set of original document data may include multiple correction instructions. In the case of one correction instruction (correction symbol), multiple correction areas may be specified.

By accumulating the original document data and the corresponding correction information based on such various correction instructions in the learning data storage unit 211, the learning unit 22 is enabled to train the correction information estimation model 23 to accommodate diverse correction instructions. The training of the correction information estimation model 23 by the learning unit 22 for each set of learning data is conducted as follows.

The learning unit 22 inputs the original document data included in the learning data into the correction information estimation model 23.

The learning unit 22 calculates the loss between the output from the correction information estimation model 23 and the correction information contained in the learning data.

The learning unit 22 updates the parameters of the correction information estimation model 23 so as to minimize the loss (i.e., so that the output from the correction information estimation model 23 approximates the correction information).

Through such a training process, the correction information estimation model 23 learns the correspondence (or tendency) between the original document data with correction instructions and the corresponding correction information. By virtue of the generalization effect of the learning, it is expected that the estimation of correction information for correction instructions not contained in the learning data will also be feasible.

Next, an explanation is provided regarding the inference phase (modification of the original document data using the trained correction information estimation model 23).

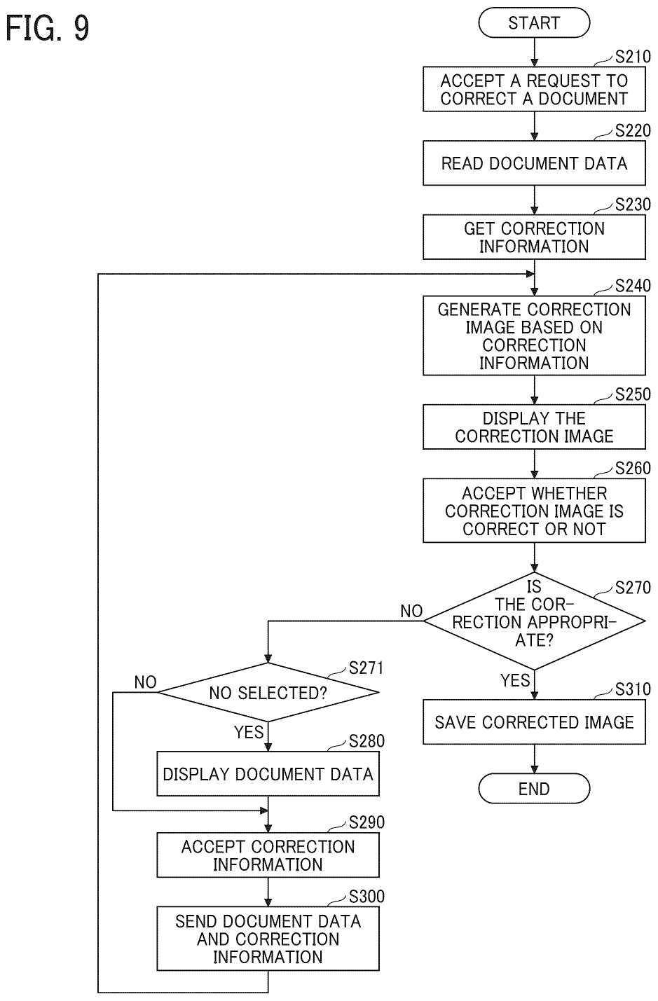

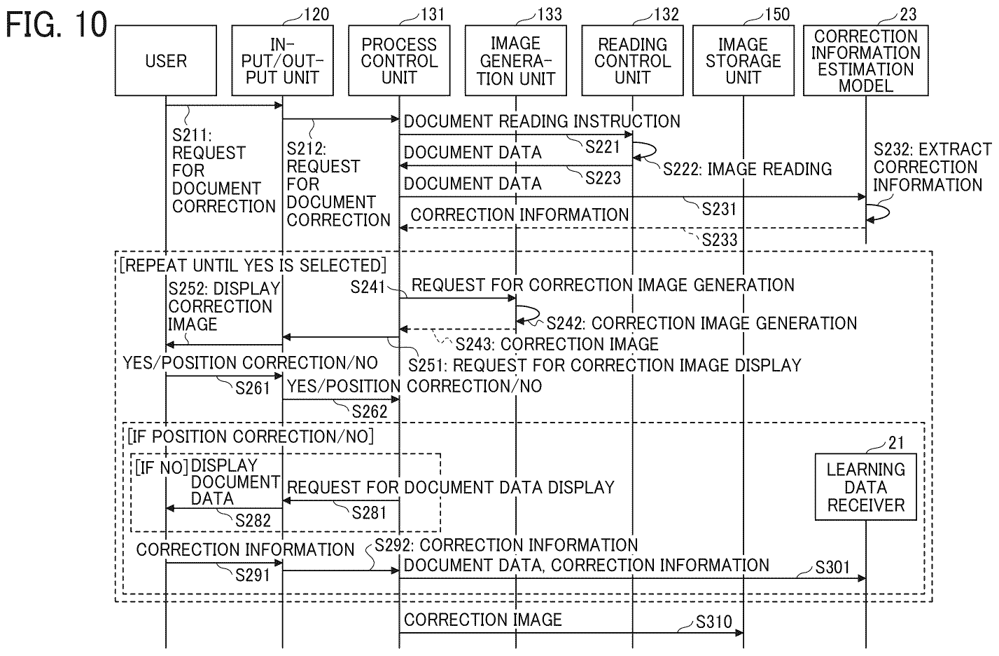

FIG. 9 is a flowchart illustrating one example of the processing steps for correcting the original document data. FIG. 10 is a sequence diagram that explains, at the functional configuration level, one example of the processing steps for correcting the original document data. In FIGS. 9 and 10, processing steps with the same two-digit prefix correspond to the same process.

At step S210 of FIG. 9, when the original document with attached correction instructions is set in the scanner 12 of the image forming apparatus 10, the user inputs a document correction request via the operation panel 15. More specifically, at step S211 of FIG. 10, when the reception unit 122 receives the input of the document correction request, it notifies the process control unit 131 of the request (S212). The document correction request may be input, for example, by pressing a predetermined button.

Next, the image forming apparatus 10 reads the image data (original document data) from the document (FIG. 9: S220). More specifically, at step S221 of FIG. 10, the process control unit 131 instructs the reading control unit 132 to read the document. The reading control unit 132 causes the scanner 12 to read the image data (original document data) from the document and acquires said data (S222). The reading control unit 132 then transmits the acquired original document data to the process control unit 131 (S223).

Subsequently, the image forming apparatus 10 obtains the first correction information corresponding to the correction instruction contained in the original document data from the trained correction information estimation model 23 (FIG. 9: S230). More specifically, at step S231 of FIG. 10, the process control unit 131 transmits (inputs) the original document data to the server apparatus 20 via the communication unit 134 (first transmission unit). Upon receiving the original document data via the communication unit 21 (second receiving unit) of the server apparatus 20, the correction information estimation model 23 inputs the original document data and outputs the first correction information corresponding to the correction instruction contained therein based on the trained parameters (S232). The communication unit 21 (second transmission unit) then transmits the first correction information to the image forming apparatus 10 (S233). The process control unit 131 receives the first correction information via the communication unit 134 (first receiving unit).

Thereafter, the image forming apparatus 10 generates a first corrected image by correcting a duplicate of the original document data based on the first correction information (FIG. 9: S240). More specifically, at step S241 of FIG. 10, the process control unit 131 transmits a generation request for the corrected image—which includes the original document data and the first correction information—to the image generation unit 133. The image generation unit 133, in response to the generation request, applies corrections corresponding to the first correction information to the duplicate of the original document data (hereinafter “duplicate data”) to generate the first corrected image (S242). As described above, the correction information includes coordinate information regarding the correction symbol, cancellation area, correction area, and the relocation destination of the correction area. The image generation unit 133 first erases, in the duplicate data, the drawing elements contained in the correction symbol and the cancellation area specified by the first correction information. Here, “drawing elements” refer to a set of pixels of a color different from the background that constitute characters, symbols, figures, images, etc. The image generation unit 133 also moves the content (set of pixels) of the correction area contained in the first correction information to the designated relocation destination. Here, “moving the correction area” means copying the correction area to the relocation destination and deleting the correction area at the original location. As a result, the correction of the duplicate data based on the first correction information is completed, and the duplicate data becomes the first corrected image. The image generation unit 133 transmits the first corrected image to the process control unit 131 (S243).

In the case where the characters in the document are printed and the correction area comprises one or more characters added by hand, the image generation unit 133 may convert the characters in the correction area to characters having the same font and size as those around the relocation destination, either before or after the movement of the correction area. By doing so, the unnatural appearance of the correction area after relocation in the first corrected image can be reduced. For example, the image generation unit 133 may use character recognition technology to convert handwritten characters in the correction area into text. It may also apply character recognition to characters within a predetermined range around the relocation destination in order to determine the font and size. The image generation unit 133 may then convert the state of the text in the correction area into an image having the determined font and size so that the font and size of the characters become identical to those surrounding the relocation destination.

Subsequently, the image forming apparatus 10 displays the first corrected image on the operation panel 15 (FIG. 9: S250). More specifically, at step S251 of FIG. 10, the process control unit 131 transmits a display request for the first corrected image along with the first correction information to the display control unit 121. In response, the display control unit 121 displays the first corrected image on the operation panel 15 (S252).

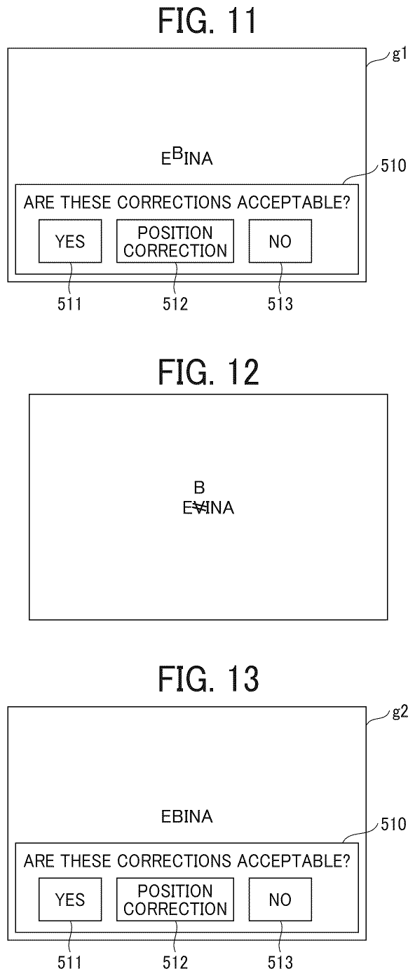

FIG. 11 shows an example of the display of the first corrected image. As shown in FIG. 11, the display control unit 121 displays a query screen 510 on the operation panel 15 for inquiring of the user whether the first corrected image g1 is acceptable. “Acceptable” in this context means that the correction applied to the original document data is appropriate (i.e., correct). The query screen 510 includes a YES button 511, a position correction button 512, and a NO button 513. The YES button 511 is provided to accept input indicating that the correction is acceptable. The NO button 513 accepts input indicating that the correction is not acceptable. The handling of the position correction button 512 will be described later.

Subsequently, the image forming apparatus 10 accepts input from the user regarding the acceptability of the first corrected image g1 (FIG. 9: S260). More specifically, at step S261 of FIG. 10, the reception unit 122 receives, via the query screen 510, the selection of one of the YES button 511, position correction button 512, or NO button 513 from the user. The reception unit 122 then erases the query screen 510 and notifies the process control unit 131 of the selected button (S262).

Thereafter, the processing branches according to whether the user has input that the correction is acceptable (i.e., selected YES button 511) or not acceptable (i.e., selected either the position correction button 512 or NO button 513) (FIG. 9: S270).

In the example shown in FIG. 11, the first corrected image g1 depicts the character “B” in “EBINA” as shifted upward, rendering the correction unacceptable. Therefore, the user selects either the position correction button 512 or the NO button 513.

When either the position correction button 512 or the NO button 513 is selected (NO in FIG. 9: S270), the image forming apparatus 10 executes a process to accept a correction to the first correction information. The first corrected image g1 was unacceptable because the first correction information output by the correction information estimation model 23 was incorrect; hence, the user is required to input correct correction information (a second correction information).

However, the correction procedure differs depending on whether the NO button 513 or the position correction button 512 is selected. In the case where the NO button 513 is selected, the entirety of the first correction information is corrected; whereas when the position correction button 512 is selected, only a part of the first correction information is corrected.

Specifically, when the NO button 513 is selected (corresponding to YES in FIG. 9: S271), the image forming apparatus 10 displays the original document data on the operation panel 15 (S280). Here, “original document data” refers to the image data read from the document in the state in which the correction instruction is still attached, as obtained at step S220. More specifically, at step S281 of FIG. 10, the process control unit 131 transmits a display request for the original document data together with the document data itself to the display control unit 121. The display control unit 121 then displays the original document data on the operation panel 15 (S282).

FIG. 12 shows an example of the display of the original document data. For convenience, FIG. 12 shows original document data containing a correction instruction similar to FIG. 6A.

Subsequently, the image forming apparatus 10 accepts input of the second correction information from the user via the original document data (FIG. 9: S290). More specifically, at step S291 of FIG. 10, the reception unit 122 accepts the second correction information input from the user. The reception unit 122 then transmits the input second correction information to the process control unit 131 (S292).

The input procedure for the second correction information is the same as that described for the input of correction information at steps S102 and S103 in FIG. 5. That is, as shown in FIGS. 6B-6D, the user specifies the correction symbol, cancellation area, and correction area by touch input or the like. As a result, the original document data is displayed in a state in which the correction symbol and cancellation area have been erased (as in FIG. 7A), and the user then specifies the relocation destination of the correction area (FIG. 7B). At step S292 of FIG. 10, the correction information based on such input is transmitted to the process control unit 131 as the second correction information.

On the other hand, in the case where the position correction button 512 is selected, the input procedure for the second correction information is different from the above. For example, in the first corrected image g1 shown in FIG. 11, only the position of the character “B” in “EBINA” is slightly off; if only the position of “B” can be corrected downward appropriately, an acceptable corrected image can be obtained. In such a case, the deviation arises because only the relocation destination in the first correction information output by the correction information estimation model 23 was erroneous, while the correction symbol, cancellation area, and correction area were estimated correctly. In such instances, it is burdensome for the user to re-specify the correction symbol, cancellation area, and correction area. Therefore, the position correction button 512 is provided as an option when only the relocation destination of the correction area is to be corrected.

Specifically, when the position correction button 512 is selected (corresponding to NO in FIG. 9: S271), step S280 is not executed; hence, the original document data is not displayed and the first corrected image remains displayed. In this state, the reception unit 122 accepts the second correction information from the user by allowing the user to correct a portion of the first correction information via the displayed first corrected image g1. In order to reduce the user's input burden, the display control unit 121 may, at step S251 of FIG. 10, overlay a rectangle on the first corrected image g1 around the correction area based on the coordinate information contained in the first correction information received from the process control unit 131. For example, the display control unit 121 may display a rectangle around the character “B” in the first corrected image g1. The user then shifts the correction area (the character “B”) to a desired position (downward) to modify the relocation destination (FIG. 10: S291). The reception unit 122 then generates the second correction information by modifying the coordinate information of the relocation destination in the first correction information in accordance with the input from the user and transmits the second correction information to the process control unit 131 at step S292.

Thereafter, the image forming apparatus transmits to the server apparatus 20, as learning data, the pair consisting of the original document data and the second correction information accepted at step S290 (S300). More specifically, at step S301 of FIG. 10, the process control unit 131 controls the process for storing the learning data, which includes the original document data and the second correction information received from the reception unit 122 at step S292, in the server apparatus 20. That is, the process control unit 131 transmits the learning data to the server apparatus 20. When the communication unit 21 of the server apparatus 20 receives the learning data, it stores the learning data in the learning data storage unit 211.

Subsequently, based on the second correction information, the steps following S240 in FIG. 9 are repeated. In this case, if the second correction information is input correctly by the user, the image generation unit 133 has a high likelihood of generating a correct second corrected image. Accordingly, at step S250, the second corrected image is likely to be displayed as intended by the user.

FIG. 13 shows an example of the display of the second corrected image. The second corrected image g2 shown in FIG. 13 represents the result in which the original document data has been corrected in accordance with the correction instruction.

When, along with the newly generated second corrected image, the query screen 510 is displayed again and the YES button 511 is selected (corresponding to YES in FIG. 9: S270), the process control unit 131 of the MPF stores the second corrected image in the image storage unit 150 (S310 in FIGS. 9 and 10). As a result, the user obtains a corrected image in which the desired corrections have been applied. For example, by printing the corrected image, the user obtains the desired document.

In the event that, at step S290 of FIG. 9, the second correction information is not input correctly by the user (i.e., the first correction information is not correctly corrected due to erroneous user operation), the second corrected image g2 may be generated with content not intended by the user. In such a case, the user may re-select either the position correction button 512 or the NO button 513 to modify the second correction information. In this case, at step S300, learning data that includes correction information different from the previous second correction information is transmitted to the server apparatus 20. The communication unit 21 may delete the previously received erroneous learning data from the learning data storage unit 211 and store the newly received learning data.

If the first correction information output by the correction information estimation model 23 is correct, the first corrected image g1 is stored in the image storage unit 150.

Subsequently, when the learning unit 22 of the server apparatus 20 accumulates a predetermined number of unlearned learning data, it performs additional training of the correction information estimation model 23 using the unlearned learning data. The method of additional training is the same as that of the initial training. As a result of the additional training, the estimation accuracy of the correction information estimation model 23 can be improved, thereby increasing the likelihood that the first corrected image will be stored in the image storage unit 150 as acceptable.

As described above, the first corrected image is displayed on the operation panel 15. Accordingly, the user can visually verify the correctness of the correction. If the correction is not acceptable, the user may input second correction information via the original document data or the first corrected image. Thus, user correction of the automatically corrected image is enabled.

Further, by having the correction information estimation model 23 learn the correspondence between image data containing correction instructions and the correction information, using a plurality of original documents that generate correction instructions in a user environment, the user is not forced to use specific correction symbols but may write correction instructions in a manner with which they are accustomed.

Although the above embodiments relate to an example in which the document containing a string is the target for correction, a document containing drawing information other than characters, such as a painting or illustration, may also be the target for correction.

The information processing apparatus is not limited to the image forming apparatus 10. The information processing apparatus may be any output device, such as a projector (PJ), an interactive white board (IWB) capable of interactive communication, a digital signage device, a head-up display (HUD) device, an industrial machine, an imaging device, a sound collection device, a medical apparatus, a network appliance, a personal computer (PC), a mobile phone, a smartphone, a tablet, a game console, a personal digital assistant (PDA), a digital camera, a wearable PC, or a desktop PC. In such cases, the information processing apparatus performs the processing on the original document data read by the image forming apparatus 10.

Furthermore, the image generation unit 133 may be a model generated by a machine learning process.

The term “machine learning” refers to a technology for endowing a computer with learning ability similar to that of a human, wherein a computer autonomously generates algorithms necessary for judgments such as data classification from pre-stored learning data, and applies these algorithms to predict new data. The learning methods for machine learning are not limited to supervised learning, unsupervised learning, semi-supervised learning, reinforcement learning, or deep learning; combinations thereof are also possible.

Also, the device groups described above merely illustrate one of several computing environments for implementing the present embodiment. In some embodiments, the image forming apparatus 10 may include a plurality of computing devices such as a server cluster. The plurality of computing devices may be configured to communicate with each other via any type of communication link, such as a network or shared memory, and perform the processing disclosed herein. Similarly, the server apparatus 20 may include a plurality of computing devices configured to communicate with one another.

Furthermore, the processing steps and examples disclosed in FIGS. 9 and 10 may be configured to be shared in various combinations. For example, the image forming apparatus 10 may include the correction information estimation model 23 and may execute all the steps.

The above-described embodiments have been explained in detail with reference to the present disclosure. However, embodiments of this disclosure may not be limited to the particular embodiments described above, and various modifications and changes can be made within the scope of the invention as defined in the appended claims.

1. An information processing apparatus, comprising:
processing circuitry configured to
receive document data from a document scanned by a scanner, the document data including an image and correction instructions;
input the document data to a correction information estimation model;
receive, from the correction information estimation model, first correction information in response to the input of the document data;
generate a first corrected image by correcting the document data based on the first correction information;
display the first corrected image; and
accept, from a user, input of second correction information corresponding to the original document data.

2. The information processing apparatus of claim 1, wherein the correction information estimation model is a machine learning model trained to identify a correspondence between image data containing correction instructions and correction information indicating a content of corrections.

3. The information processing apparatus of claim 1, wherein the processing circuitry is further configured to generate a second corrected image by correcting the document data based on the second correction information accepted from the user.

4. The information processing apparatus of claim 1, wherein the processing circuitry is further configured to display the document data, and accept the second correction information via the displayed document data.

5. The information processing apparatus of claim 1, wherein the processing circuitry is further configured to accept the input of the second correction information via the displayed first corrected image.

6. The information processing apparatus of claim 1, wherein the first correction information comprises at least one of: a correction symbol, a cancellation area canceled by the correction indicated by the correction symbol, a correction area designated as a relocation target, and a relocation destination for the correction area.

7. The information processing apparatus of claim 1, wherein the correction instructions are handwritten additions to the document.

8. The information processing apparatus of claim 1, wherein the processing circuitry is further configured to:
control storage of the original document data and the second correction information, as learning data, in a learning data storage for the correction information estimation model.

9. The information processing apparatus of claim 1, further comprising the scanner.

10. The information processing apparatus of claim 1, further comprising a display, wherein
the display includes a touchscreen interface, and
the processing circuitry is further configured to
display the first corrected image on the display, and
accept the second correction information from the user via the touchscreen interface of the display.

11. The information processing apparatus of claim 1, further comprising:
a display; and
an input interface, wherein
the processing circuitry is further configured to
display the first corrected image on the display, and
accept the second correction information from the user via the input interface.

12. An information processing system, comprising:
an information processing apparatus; and
a server, wherein
the information processing apparatus includes first circuitry configured to:
transmit original document data, read from a document with correction instructions attached, to the server;
receive first correction information from the server apparatus;
generate a first corrected image by correcting the document data based on the first correction information; and
display the first corrected image, and
the server includes second circuitry configured to:
receive the document data from the information processing apparatus;
input the document data to a correction information estimation model;
receive, from the correction information estimation model, first correction information in response to the input of the document data; and
transmit the first correction information to the information processing apparatus.

13. The information processing system of claim 12, wherein the correction information estimation model is a machine learning model trained to identify a correspondence between image data containing correction instructions and correction information indicating the content of corrections.

14. An information processing method performed by processing circuitry of an information processing apparatus, the information processing method comprising:
receiving document data from a document scanned by a scanner, the document data including an image and correction instructions;
inputting the document data to a correction information estimation model;
receiving, from the correction information estimation model, first correction information in response to the input of the document data;
generating a first corrected image by correcting the document data based on the first correction information;
displaying the first corrected image; and
accepting, from a user, input of second correction information corresponding to the original document data.

15. The information processing method of claim 14, wherein the correction information estimation model is a machine learning model trained to identify a correspondence between image data containing correction instructions and correction information indicating a content of corrections.

16. The information processing method of claim 14, further comprising generating a second corrected image by correcting the document data based on the second correction information accepted from the user.

17. The information processing method of claim 14, further comprising:
displaying the document data; and
accepting the second correction information via the displayed document data.

18. The information processing method of claim 14, further comprising accepting the input of the second correction information via the displayed first corrected image.

19. The information processing method of claim 14, wherein the first correction information comprises at least one of: a correction symbol, a cancellation area canceled by the correction indicated by the correction symbol, a correction area designated as a relocation target, and a relocation destination for the correction area.

20. The information processing method of claim 14, wherein the correction instructions are handwritten additions to the document.
